(19) United States
(12) Patent Application Publication
(10) Pub. No.: US 2016/0034965 A1
(43) Pub. Date: Feb. 4, 2016

(54) SYSTEM FOR TRANSMITTING AND DISPLAYING AT LEAST ONE PECULIAR MULTIMEDIA CONTENT FILE TO ONE OR MORE WIRELESS COMMUNICATION EQUIPMENT

(71) Applicants: Giovanni GUERRI, Reggio Emilia (IT); Nicola IOTTI, Bibbiano (IT)

(72) Inventors: Giovanni GUERRI, Reggio Emilia (IT); Nicola IOTTI, Bibbiano (IT)

(21) Appl. No.: 14/449,344

(22) Filed: Aug. 1, 2014

(51) Int. Cl. G06Q 30/02

(52) U.S. Cl. CPC G06Q 30/0267; G06Q 30/0261

(57) ABSTRACT

An internet multimedia content file system for providing a business enterprise an automatic login system of the user of the business enterprise internet, collecting data on the users and transmitting to users appropriate multimedia content files soliciting the purchase of a product or service at the appropriate moment via the user wireless communication equipment. The business enterprise mentioned is in particular the consumer product industry and any other industries that supply products and/or services, for example a store, a department store chain, a restaurant, a beauty center.

### TECHNICAL FIELD

The invention relates to the transmission of peculiar multimedia content files to the wireless communication equipment was connected at least once to a wireless internet connection provided by a business enterprise.

### BACKGROUND

The business enterprises, in particular the consumer product industries but not only them, need to solicit their users to buy choosing the appropriate moment and the appropriate way to solicit their purchases.

The business enterprises increasingly embrace electronic promotion techniques, providing web-based promotion material previously available only through print or traditional broadcast, having identified in the web a powerful promotion instrument.

However the internet information providers have little or no control over the viewing process of the multimedia content files and unwanted or uninteresting contents may be easily ignored by the internet addressee of the multimedia content file.

One technique to reduce the ignored multimedia content file being unwanted or uninteresting by the internet addressee of the multimedia content file is the recommendation services. They are based on the analysis of the item purchased via internet by a specific person or the favorite web pages of that person.

Another recommendation technique is known as collaborative filtering. This technique commonly operates by having the addressee of the recommendation explicitly rate individual item from a list of items, building a personal profile of his or her preferences. See U.S. Pat. No. 5,583,763 and 5,749,081.

However the recommendation services do not consider some studies showing the people have a quite limited period of time during which they have an interest for some specific object or service.

They also do not collect and record the data from the habits and the behaviors of the users automatically.

For example, a person might be interested to have a lunch in an Italian restaurant being at the Italian area of the grocery in a department store and being lunch time. In case a specific department store has an Italian restaurant as well as an Italian area in its grocery, it will be very useful for the person to receive a multimedia content file informing him/her that Italian restaurant of the department store is located at a certain floor, having also the menu of that restaurant and the number of seats available, hereinafter designated as “the Italian restaurant at the department store example.”

Therefore the business enterprises have to solicit the user with appropriate multimedia content file and they have to be able to identify the moment which a person has an interest for their specific object or service offering it in that moment.

Therefore the business enterprises have to send their appropriate multimedia content file to the user timely. The multimedia content file having these characteristics can be qualified peculiar multimedia content file, namely a not usual multimedia content file but a multimedia content file offering a specific product or service at the time that most probably the user is inclined to purchase.

For the foregoing reasons, there is a need to have one single system able to provide access to internet in an automatic and effective way for an improved internet messaging system allowing a business enterprise, in particular the consumer product industries but not only them, to transmit and display on the user wireless communication equipment a multimedia content file soliciting the purchase of a product or service at the appropriate moment, identifying said moment by the physical position of the user and/or by a number of information stored in the business enterprise data base.

### DESCRIPTION OF THE INVENTION

The present invention is directed to an improved internet multimedia content file system that satisfies the need for providing the business enterprise of an automatic login system of the user of the business enterprise internet, collecting data on the users and transmitting to user a appropriate multimedia content file soliciting the purchase of a product or service at the appropriate moment by the user wireless communication equipment. The business enterprise mentioned is in particular the consumer product industry and any other industries that supply products and/or services, for example a store, a department store chain, a restaurant, a beauty center.

The system comprises a set of devices and equipment described here below.

One of the devices is a first electronic device for a wireless communication equipment of the user with his or her consent or request: the user can be anybody provided that he or she has the first electronic device on his or her wireless communication equipment. The first electronic device can be either software as a hardware device. The wireless communication equipment can be a Smartphone, a tablet or any equipment able to be connected to internet by wireless and to receive and display at least one multimedia content file.

The first electronic device, hereinafter designated as “I+C device”, makes the user wireless communication equipment having that I+C device, hereinafter designated as “I+C wireless equipment”, identifiable, identified and automatically connectable by a certain wireless connection managed by the business enterprise, hereafter designated as “business enterprise internet”, within a specific area, hereinafter designated as “coverage area”, logging out the previous internet communication service. In other words, the I+C wireless equipment made its login automatically to the business enterprise internet within a coverage area dropping the previous internet communication service or keeping connected also the previous internet communication service alternatively.

The I+C device moreover allows the I+C wireless equipment to dialog with a first electronic processing device via the business enterprise internet and to connect the wireless communication equipment to internet by the business enterprise internet. It can be integrated into the software managed by the business enterprise.

The I+C wireless equipment is identified by a second electronic device, hereafter designated as “AAA system” which also allows the I+C wireless equipment to be connected to the business enterprise internet automatically.

The system include at least a first electronic processing device configured for dialoging with the I+C equipment. This first electronic processing device is configured, in particular, for soliciting and processing data from each I+C wireless equipment when connected to the business enterprise internet in accordance to a criteria stated by the business enterprise, hereinafter designated as “processed data”. This first electronic processing device is also configured for selecting on the basis of the processed data at least one predetermined multimedia content file stored in a database, hereinafter designated as “selected multimedia content file” and transmitting the selected multimedia content file to the I+C wireless equipment or to the I+C device alternatively via the business enterprise internet or a communication service alternatively.

In an embodiment of the present invention, the database of the system is configured to store by each I+C wireless equipment the processed data, hereafter after designated as “stored data” and the first electronic processor device is configured also to select on the basis of the stored data the selected multimedia content file. The utility of this embodiment is to increase the purchase of the products and/or the services from the business enterprise considering that some empirical studies have shown that it is very valuable to know where, when and the habits of a user related to the business of the business enterprise in a specific moment automatically.

An example of the operation of the first electronic processing device and the database can be made recalling the Italian restaurant at the department store example. We have a department store with its business enterprise internet and some of the persons visiting the department store have the I+C wireless equipment. One of the criteria stated by the department store configured into the first electronic processing device is to record all the departments where is and has been each I+C wireless equipment, therefore the department visited by the persons having the I+C wireless equipment. The department store of our example is a chain and it has several branches in several cities having all an Italian restaurant. The I+C wireless equipment of our example has been in an Italian restaurant of the department store chain of a certain city. I+C wireless equipment made its automatic login to the Business Enterprise Internet of department store chain in another city. The second electronic device identified the I+C wireless equipment for connecting it to the business enterprise internet of the department store chain of that city. The first electronic processing device is also configured for: (i) soliciting the I+C wireless equipment connected to that business enterprise internet to identify their position; (ii) processing the data received by the I+C wireless equipments selecting the processed data related to that I+C equipments; (iii) identify that I+C wireless equipments has been in the Italian restaurant area of the department store chain in other cities, being it one of the criteria stated by the department store; (iii) selecting the multimedia content file stored in the database of the menu of that specific day of the Italian restaurant of that department store of that city as well as its location, being said multimedia content file of the menu plus the restaurant location for this example the selected multimedia content file according to the definition above, namely the predetermined multimedia content file selected on the basis of the processed data; iv) transmitting via the department store internet or a communication service alternatively the menu plus the restaurant location to I+C wireless equipment or to the I+C device alternatively.

In the example above, the multimedia content file is transmitted to I+C wireless equipment holders offering a service, the Italian restaurant because that I+C wireless equipment holders are inclined to purchase the services of the Italian restaurant: being a regular client and he or she has interest in Italian food.

Some empirical studies have shown that it is very valuable to know where and when a user is in a specific moment. Therefore the first electronic processor device can be configured to identified where and when the I+C wireless equipment is connected to the business enterprise internet, therefore where and when the I+C wireless equipment holder is in the coverage area of the business enterprise, become a client with a high probability for purchasing the products or the services offered by the business enterprise. This feature is possible because the I+C wireless equipment is connected automatically to the business enterprise internet when it is in the coverage area.

For those reasons, the first electronic processor device is configured to obtain as processed data: (a) the specific business location of the business enterprise where the I+C wireless equipment is; (b) the specific classified area of the business location of the business enterprise where the I+C wireless equipment is; (c) the time when the wireless equipment is in the coverage area of a specific business location of the business enterprise; (d) when the I+C wireless equipment is in a specific classified area of the business location of the business enterprise.

For the same reason above, the data base is configured to store as stored data: (α) the duration of the I+C wireless equipment connection to the business enterprise internet of a business location of the business enterprise; (β) the duration of the I+C wireless equipment connection to the business enterprise internet of a specific classified area of the business location of the business enterprise.

The data above mentioned are the most valuable based on some empirical studies, however the stored data can also coming from other sources.

### DESCRIPTION OF THE DRAWINGS

FIG. 1 illustrates the business enterprise internet (1), a first electronic device (2) the I+C wireless equipment (3), the AAA system (4) and their connections.

FIG. 2 illustrates the I+C wireless equipment (3), first electronic processing device (5), the database (6) and their connections.

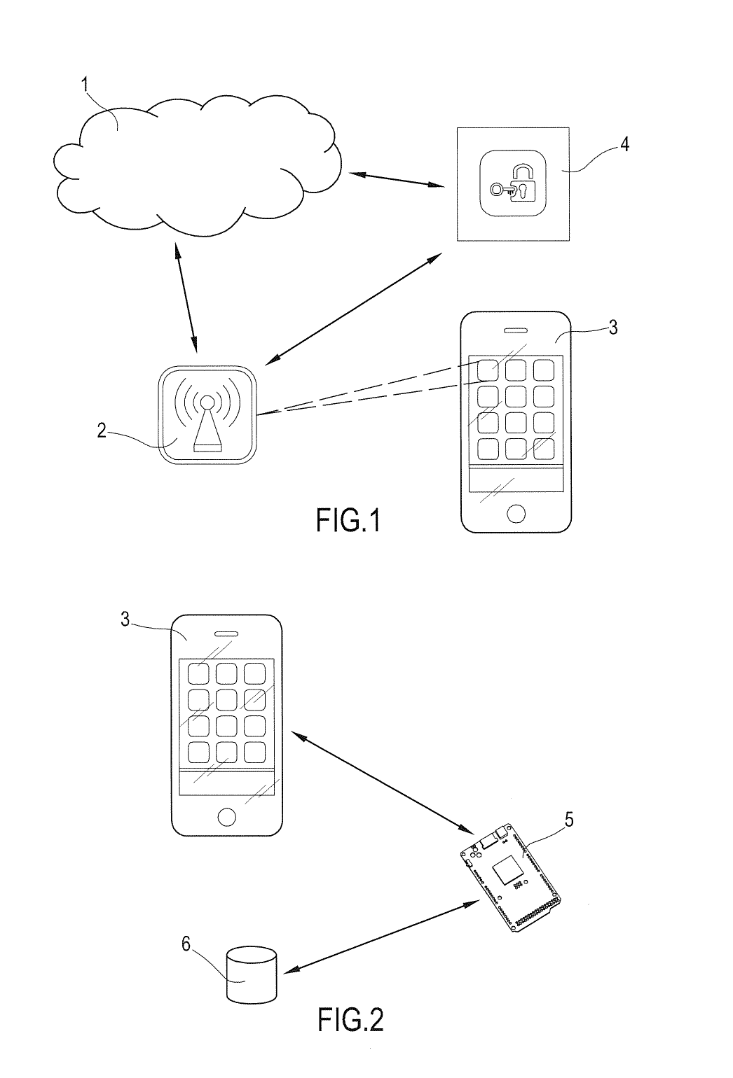

In the FIG. 1 shows the some of the devices of the invention and their connections.

A wireless internet connection provided and managed by the business enterprise (business enterprise internet) is represented by an antenna 1.

A first electronic device for a wireless communication equipment for identifying and connecting a wireless communication equipment to the business enterprise internet (1) within a specific area automatically (coverage area), not represented graphically, allowing a wireless communication equipment to dialog with a first electronic processing device, represented in the FIG. 2, via the business enterprise internet (1) to be integrated into the software managed by the business enterprise, to connect the wireless communication equipment to internet by the business enterprise internet (I+C device). This device is identified with 2. It can be hardware or software installed on a wireless equipment as a smart phone, tablet, for example.

A wireless communication equipment having the I+C device (I+C wireless equipment). This device is identified with 3.

A second electronic device to identify and allow the I+C wireless equipment to connect it to the business enterprise internet automatically. This device is identified with 4.

The arrows in the FIG. 1 show the connections of the devices to perform the invention.

In the FIG. 2 shows the some of the devices of the invention and their connections.

A wireless communication equipment having the I+C device (I+C wireless equipment). This device is identified with 3.

A first electronic processing device (5) configured for dialoging with the I+C wireless equipment.

A first electronic processing device (5) configured for dialoging with the I+C wireless equipment, processing data and performing the function in accordance to the invention describe above.

A database (6) configured to store the processed data (stored data) and predetermined multimedia content files.

The arrows in the FIG. 2 show the connections of the devices to perform the invention.

What is claimed is:

1. A system for transmitting at least one peculiar multimedia content file to one or more wireless communication equipments connected to a wireless internet connection provided by a business enterprise at least once wherein it comprises:
a. a wireless internet connection provided and managed by the business enterprise (business enterprise internet);
b. a first electronic device for a wireless communication equipment for identifying and connecting a wireless communication equipment to the business enterprise internet within a specific area automatically (coverage area), allowing a wireless communication equipment to dialog with a first electronic processing device via the business enterprise internet to be integrated into the software managed by the business enterprise, to connect the wireless communication equipment to internet by the business enterprise internet (I+C device);
c. a wireless communication equipment having the I+C device (I+C wireless equipment);
d. a second electronic device to identify and allow the I+C wireless equipment to connect it to the business enterprise internet automatically;
e. at least a first electronic processing device configured for dialoging with the I+C wireless equipment.

2. The system for transmitting at least one peculiar multimedia content file in accordance to claim 1 wherein the first electronic processing device is configured for soliciting and processing data from each I+C wireless equipment when connected to the business enterprise internet in accordance to a criteria stated by the business enterprise (processed data), selecting on the basis of the processed data at least one predetermined multimedia content file and stored in a database (selected multimedia content file) transmitting the selected multimedia content file to the I+C wireless equipment or the I+C device alternatively via the business enterprise internet or a communication service alternatively.

3. The system for transmitting at least one peculiar message in accordance to claim 2 wherein the database is configured to store by each I+C wireless equipment the processed data (stored data) and the first electronic processor device is configured to select a predetermined multimedia content file stored in the database in accordance to a criteria stated by the business enterprise on the basis of the stored data.

4. The system for transmitting at least one peculiar message in accordance to claim 2 wherein the processed data are the specific business location of the business enterprise where the I+C wireless equipment is;

5. The system for transmitting at least one peculiar message in accordance to claim 2 wherein the processed data are a specific classified area of the business location of the business enterprise where the I+C wireless equipment is.

6. The system for transmitting at least one peculiar message in accordance to claim 3 wherein the stored data are the date and time when the wireless equipment is in the coverage area of a specific business location of the business enterprise.

7. The system for transmitting at least one peculiar message in accordance to claim 3 wherein the stored data are the date and time when the wireless equipment is in a specific classified area of the business location of the business enterprise.

8. The system for transmitting at least one peculiar message in accordance to claim 3 wherein the stored data are the duration of the I+C wireless equipment connection to the business enterprise internet of a business location of the business enterprise.

9. The system for transmitting at least one peculiar message in accordance to claim 3 wherein the stored data are the duration of the I+C wireless equipment connection to the business enterprise internet of a specific classified area of the business location of the business enterprise.

10. The system for transmitting at least one peculiar message in accordance to the claims 3 wherein the stored data are data coming from other sources too.
